(19) United States
(12) Patent Application Publication
(10) Pub. No.: US 2014/0311916 A1
(43) Pub. Date: Oct. 23, 2014

(54) High Surface Area Reticulated Vitreous Carbon-Nanoparticle Metal Oxide Electrodes

(71) Applicant: The University of North Carolina at Chapel Hill, Chapel Hill, NC (US)

(72) Inventors: Manuel Mendez Agudelo, Duebendorf (CH); Leila Alibabaei, Carrboro, NC (US); Javier J. Concepcion, Upton, NY (US); Christopher J. Dares, Chapel Hill, NC (US); Thomas J. Meyer, Chapel Hill, NC (US)

(73) Assignee: THE UNIVERSITY OF NORTH CAROLINA AT CHAPEL HILL, Chapel Hill, NC (US)

(21) Appl. No.: 14/224,606

(22) Filed: Mar. 25, 2014

Related U.S. Application Data
(60) Provisional application No. 61/804,790, filed on Mar. 25, 2013.

(51) Int. Cl. C25B 11/04; B01J 31/26; C25B 1/04

(52) U.S. Cl. CPC C25B 11/04; C25B 1/04; B01J 31/26
USPC 205/630; 204/294; 252/506; 502/101

(57) ABSTRACT

The present invention provides, in some embodiments, hybrid materials having reticulated vitreous carbon (RVC) and nanoparticles of a conductive, transparent metal oxide such as tin-doped indium oxide (ITO). The material can further include one or more transition metal catalysts, such as {Ru(Mebimpy)[4,4′-((HO)₂OPCH₂)₂bpy](OH₂)}²⁺. Oxidation of water, benzyl alcohol, and other useful reactants is possible when the material is employed as an electrode.

### RELATED APPLICATIONS

This application claims the benefit under 35 U.S.C. §119(e) of U.S. Provisional Patent Application No. 61/804,790 filed Mar. 25, 2013, entitled, “HIGH SURFACE AREA RETICULATED VITREOUS CARBON-NANOPARTICLE METAL OXIDE ELECTRODES,” the disclosure of which is incorporated herein by reference in its entirety.

### STATEMENT REGARDING FEDERALLY SPONSORED RESEARCH OR DEVELOPMENT

This invention was made with government support under Grant Nos. DE-SC0001298 and DE-SC0001011 awarded by the Department of Energy and Grant No. 0165095-002 awarded by the Research Triangle Institute, RTI International. The U.S. Government has certain rights in the invention.

### FIELD OF INVENTION

This invention relates to combinations of vitreous carbon with conductive nanoparticles of metal oxides. Such combinations can appear, for example, in the form of a catalyst-supporting electrode.

### BACKGROUND OF THE INVENTION

Reticulated vitreous carbon (RVC) is a high-surface area material useful in numerous applications. Electrically conductive and porous, the material has found use in electrochemical applications, especially as an electrode material. However, RVC suffers from oxidative instability at high temperatures in the presence of oxygen or at elevated anodic potentials. Moreover, RVC is difficult to derivatize: techniques for contacting RVC with catalysts and other useful species are few.

### SUMMARY OF THE INVENTION

Unexpectedly, Applicants have achieved higher surface area-to-volume ratios by combining high surface area RVC electrodes with stable nanoparticles of tin-doped indium oxide (nanoITO) followed by surface derivatization. Broadly, some embodiments of the present invention provide a RVC material in combination with nanoparticles of a conductive metal oxide. Other embodiments provide a RVC material in combination with nanoparticles of a conductive transparent metal oxide. Still other embodiments of the present invention provide a RVC material in combination with nanoparticles of tin-doped indium oxide (ITO), fluorine doped tin oxide (FTO), antimony tin oxide (ATO), gallium zinc oxide (GZO), indium zinc oxide (IZO), copper aluminum oxide (CAO), fluorine doped zinc oxide (FZO), and aluminum zinc oxide (AZO), or a combination thereof. In certain cases, those two materials (RVC and nanoparticles) together are formed into electrodes. The resulting hybrid electrodes provide a versatile platform for a variety of applications in analysis and electrocatalysis, among other uses. For example, certain embodiments can be used for electrocatalytic water oxidation and oxidation of organics by surface-bound transition metal catalysts and, potentially, to interfacial proton-coupled electron transfer (POET). In still other embodiments, RVC is stabilized against oxidation by providing nanoparticles of a metal oxide in protective contact with the RVC.

Some embodiments of the present invention provide electrodes comprising: reticulated vitreous carbon and nanoparticles of a conductive metal oxide in electrical communication with the reticulated vitreous carbon.

Other embodiments provide methods for preparing an electrode comprising: annealing reticulated vitreous carbon in the presence of nanoparticles of a conductive metal oxide for a period of time and at a temperature sufficient to place at least some of the nanoparticles in electrical communication with the reticulated vitreous carbon, thereby preparing the electrode.

Still other embodiments relate to methods for electrolyzing a reactant, comprising: providing an electrochemical cell having an electrode that comprises reticulated vitreous carbon and nanoparticles of a conductive metal oxide in electrical communication with the reticulated vitreous carbon; contacting the electrode with the reactant; and applying electrical energy to the electrode, thereby electrolyzing the reactant.

Additional embodiments provide methods for stabilizing reticulated vitreous carbon, comprising: annealing reticulated vitreous carbon in the presence of nanoparticles of a conductive metal oxide for a period of time and at a temperature sufficient to place at least some of the nanoparticles in protective communication with the reticulated vitreous carbon, thereby stabilizing the reticulated vitreous carbon.

### BRIEF DESCRIPTION OF THE DRAWINGS

FIG. 1 shows conceptually, in one embodiment of the present invention, the structure of [Ru(Mebimpy)(4,4′-((HO)₂OPCH₂)₂bpy)(OH₂)]²⁺ on nanoITO illustrating the stepwise mechanism for water oxidation.

FIG. 2 shows, in other embodiments, SEM micrographs: a) RVC electrode; b)-d) RVC|nanoITO electrodes prepared by dip-coating from suspensions of nanoITO, b) 10, c) 100 and d) 200 mg/mL in ethanol. Cross-sections of the electrode in c) are presented in e) and f), where the scale bars represent 2 μm.

FIG. 3 shows, in further embodiments, SEM micrographs of RVC|nanoITO electrodes prepared by spin coating from suspensions of nanoITO a) 25, b) 31, c) 62, d) 125 mg mL⁻¹.

FIG. 4 shows, in yet another embodiment, SEM images of ITO coated RVC made by spin-coating a 60 mg/mL suspension of nanoITO in ethanol/acetic acid showing: a) Overall uniform surface coverage; b) Edge coverage; c) Preservation of the substrate morphology after addition of the ITO layer; d) Uniform ITO layer thickness measured using FIB patterning.

FIG. 5 shows an additional embodiment depicted in SEM images of a) FTO coated RVC made using a 60 mg/mL suspension of nanoFTO in ethanol/acetic acid showing overall uniform surface coverage, and b) edge coverage.

FIG. 6 provides yet another embodiment depicted in SEM Images of a) ATO coated RVC made using a 60 mg/mL suspension of nanoATO in ethanol/acetic acid showing overall uniform surface coverage, and b) edge coverage.

FIG. 7 provides for further embodiments of the present invention showing a) UV-visible absorption spectra of 1-PO₃H₂, 0.1 mM in methanol (Solid Black), before and after loading dip coated RVC|nanoITO to give RVC|nanoITO-Rull-OH₂²⁺. Loadings were from suspensions of 100 (Solid Gray) and 10 (Dotted Black) mg mL⁻¹ of nanoITO in ethanol. Cyclic voltammograms in an acetate buffer at pH 5 (I=0.1) at 5 mV s⁻¹ are shown in b) (100 mg mL⁻¹) and c) (10 mg mL⁻¹), respectively. RVC area=19.5 cm².

FIG. 8 provides for a different embodiment cyclic voltammograms at a RVC|nanoITO-Ru^{II}-OH₂²⁺ electrode in acetate buffer pH 5 (I=0.1) at 5 mV/s with: a) 0, b) 1.5, c) 3.0 and d) 5.9 mM of added benzyl alcohol. RVC area=19.5 cm².

FIG. 9 illustrates for an additional embodiment cyclic voltammograms of K₄Fe(CN)₆ (0.5 mM) in an aqueous solution with 1 M KCl 10 mV s⁻¹ at: a) a glassy carbon disk, b) RVC (Dashed Black) and nanoITO|RVC (Solid Black) electrodes: SCE reference, Pt mesh counter electrode.

FIG. 10 provides, for yet another embodiment (Top) SEM micrograph of uncovered area of RVC|nanoITO electrodes prepared from a 10 mg/mL suspension of nanoITO in ethanol. (Bottom) EDS spectrum of the area highlighted in the box in the top.

FIG. 11 illustrates for even another embodiment (Top) SEM micrograph of covered area of RVC|nanoITO electrodes prepared from a 100 mg/mL suspension of nanoITO in ethanol. (Bottom) EDS spectrum of the area highlighted in the box in the top.

FIG. 12 provides, for a further embodiment, (a) cyclic voltammograms in pH 5 acetate buffer (I=0.1 M) of RVC|nanoITO-Ru^{II}-OH₂²⁺ electrodes previously loaded with 1-PO₃H₂ at 2, 3, 5, 7, 10, 15 and 20 mV/s. (b) Anodic and cathodic peak currents obtained in a) as a function of the scan rate. SCE reference electrode and Pt mesh counter electrode.

FIG. 13 illustrates for one embodiment current-time plot for controlled potential electrolysis of RVC|nanoITO-Ru^{II}-OH₂²⁺ electrodes previously loaded with 1-PO₃H₂ at 1.05 V vs. SCE with 30 mM added benzyl alcohol. pH=5, I=0.1 M at 23±2° C.

FIG. 14 provides for that embodiment ¹H-NMR spectra of the extract in CDCl₃ of the liquid phase in FIG. 13 at electrolysis times of a) 0 and b) 2.2 hours. Enlarged spectra of a) and b) in the region comprehended between 10.5 and 7.5 ppm are presented in c) and d), respectively.

FIG. 15 illustrates, for an embodiment of the present invention, Charge passed as a function of time for a controlled electrolysis experiment for oxygen production at RVC|nanoITO-Ru^{II}-OH₂²⁺ electrodes previously loaded with 1-PO₃H₂ in HClO₄ 0.1 M at 1.4 V vs. SCE. The inset shows the gas chromatogram obtained before electrolysis (Hatched), after 50 minutes (White) and an air sample (Black).

### DETAILED DESCRIPTION

The foregoing and other aspects of the present invention will now be described in more detail with respect to the description and methodologies provided herein. It should be appreciated that the invention can be embodied in different forms and should not be construed as limited to the embodiments set forth herein. Rather, these embodiments are provided so that this disclosure will be thorough and complete, and will fully convey the scope of the invention to those skilled in the art.

The terminology used in the description of the invention herein is for the purpose of describing particular embodiments only and is not intended to be limiting of the invention. As used in the description of the embodiments of the invention and the appended claims, the singular forms “a”, “an” and “the” are intended to include the plural forms as well, unless the context clearly indicates otherwise. Also, as used herein, “and/or” refers to and encompasses any and all possible combinations of one or more of the associated listed items. Furthermore, the term “about,” as used herein when referring to a measurable value such as an amount of a compound, dose, time, temperature, and the like, is meant to encompass variations of 20%, 10%, 5%, 1%, 0.5%, or even 0.1% of the specified amount. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. Unless otherwise defined, all terms, including technical and scientific terms used in the description, have the same meaning as commonly understood by one of ordinary skill in the art to which this invention belongs.

Additional embodiments provide RVC, nanoparticles of a conductive metal oxide, and at least one transition metal catalyst. Any suitable transition metal catalyst can be used, such as, for example, those comprising Ruthenium, Iridium, or Osmium. One suitable catalyst is [Ru(Mebimpy)(4,4′-((HO)₂OPCH₂)₂bpy)(OH₂)]²⁺ (Mebimpy=2,6-bis(1-methylbenzimidazol-2-yl)pyridine; bpy=2,2′-bipyridine) (1-PO₃H₂).

Applicants and colleagues have recently reported electrodes comprising nanoparticles of metal oxides suitable for use in certain embodiments of the present invention. See U.S. patent application Ser. No. 13/575,422, entitled, “Nanoparticle Electrodes and Methods of Preparation,” originally filed as PCT/US2011/0021978 and published as U.S. Pat. App. Pub. No. 2013/0020113, which is incorporated herein by reference in its entirety. Those electrodes optionally comprise transition metal catalysts, which also can be used in some embodiments of the present invention.

Embodiments of the present invention can be made according to any suitable procedure. In some cases, RVC is dip-coated into a suspension of nanoparticles. In other cases, RVC is contacted with a suspension of nanoparticles and spun, thereby spin-coating the RVC. Any combination of drying, heating, cooling slowly or with temperature control, and the like, in any suitable atmosphere such as air, nitrogen, hydrogen/nitrogen, anhydrous, vacuum, partial vacuum, or appropriate combinations thereof can be employed.

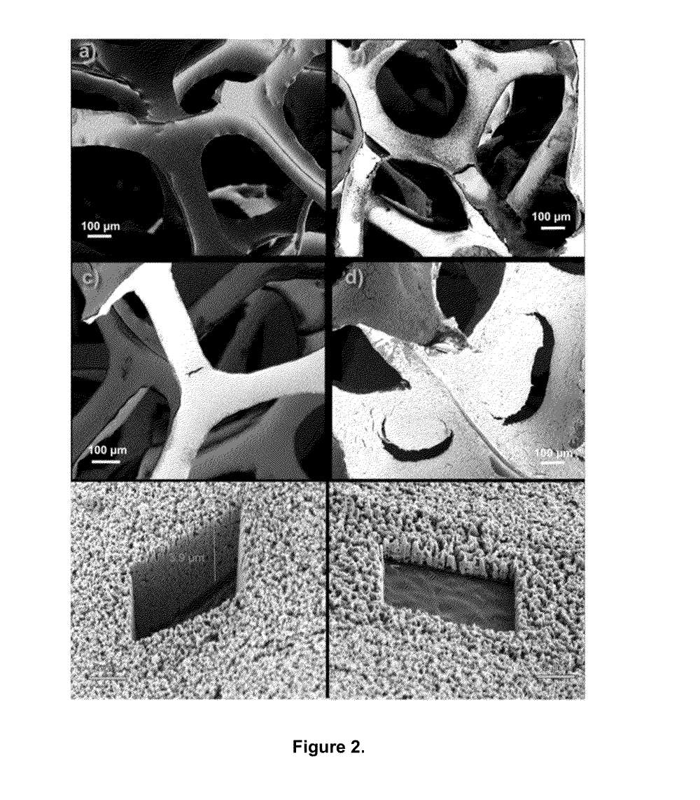

Applicants have successfully reduced certain embodiments of the present invention to practice. RVC (pores/inch=45; porosity: 96.5%; bulk density: 0.048 g cm⁻³) was purchased from ER&G Aerospace. Cylinders and blocks with a variety of diameters were used, made from larger cubes. Typically, cylinders with a diameter of 9 mm, and a height of 10 mm, using a pre-made form were used. The geometric surface area of the RVC was calculated according to eq. 1,

$${SA}_{RVC} = \frac{{m}_{RVC} {A}_{V}}{ρ} \qquad ( 1 )$$

where m_{RVC} is the mass of the RVC, A_{V} is the surface to volume ratio (29.7 cm²/mL for 45 pores/inch RVC), and p is the density. RVC electrodes were modified by nanoparticles of metal oxides by a dip-coating or spin-coating procedure using suspensions of different metal oxide nanoparticle concentrations in ethanol or a 10:3 ethanol/acetic acid mixture. Film homogeneity and thickness were evaluated by scanning electron microscopy (SEM) and focused ion beam (FIB) patterning with the influence of nanoparticle concentration on film coverage being shown in FIG. 2.

RVC electrodes modified by nanoparticles of nanoITO by dip-coating were immersed in a suspension of nanoITO in ethanol for 10 min, after which they were removed and annealed in a tube furnace in a nitrogen atmosphere with 5 mol % hydrogen at 500° C. Dip-coating from 10 mg mL⁻¹ suspensions, gave uneven coverage, and discontinuous film formation, as shown in the example imaged in FIG. 2(b). Some embodiments of the present invention do not require a complete film of nanoparticles on the RVC, however. Complete coverage was achieved with 100 mg mL⁻¹ (FIG. 2(c)), and 200 mg mL⁻¹ (FIG. 2 (d)) suspensions. However, by 200 mg mL⁻¹, ITO particles accumulate and begin to block the pores of the RVC after annealing. See FIG. 2(d). While not ideal for certain applications, such embodiments still work and are suitable for other applications. For some applications, optimal properties using a dip-coating technique were obtained at 100 mg mL⁻¹ ITO with maximized film coverage free of pore blocking. One of ordinary skill in the art will appreciate that various parameters will affect the application of nanoparticles to the RVC, such as for example time and temperature, concentration of the suspension, and how vigorously the RVC may be handled to remove excess nanoparticle suspension after dipping.

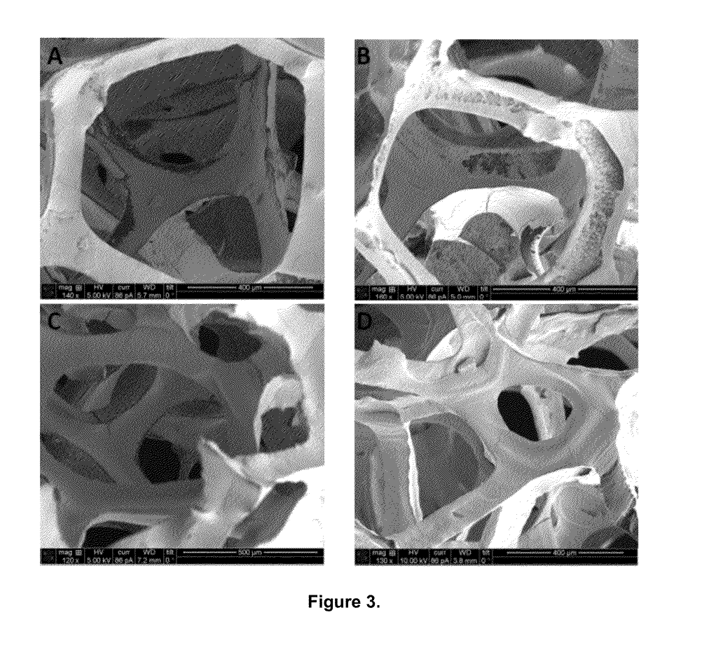

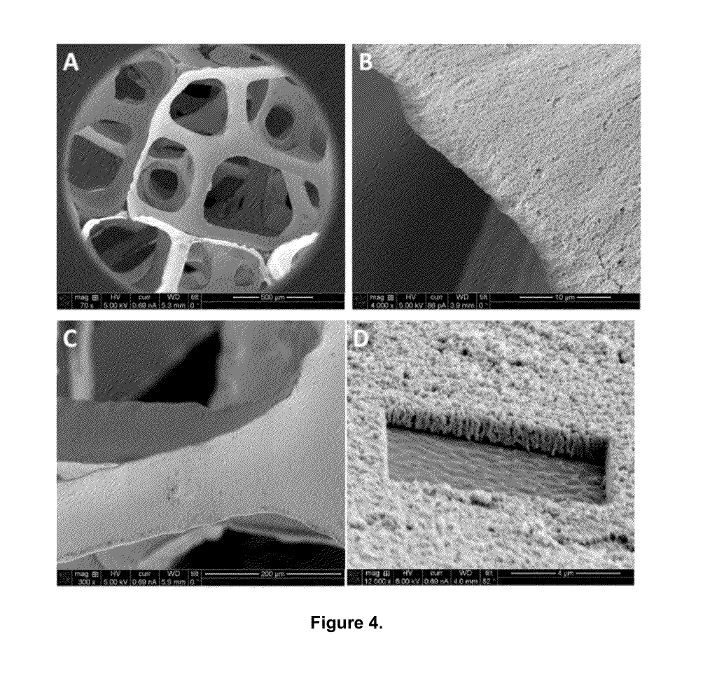

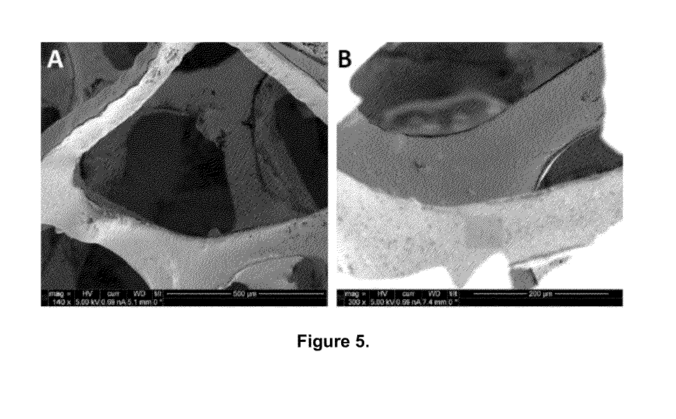

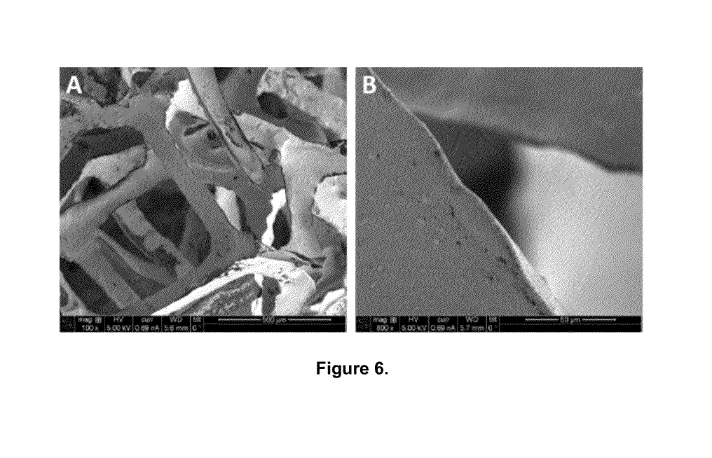

RVC electrodes modified by nanoparticles of various metal oxides by spin-coating were achieved through the following procedure. A pilot hole was drilled through 90% of the length of the RVC sample. A graphite rod was then pushed through the pilot hole in the RVC until just before puncturing the far side of the RVC. The graphite rod/RVC electrode was then mounted on a motor. A suspension of sonicated nanoITO in ethanol-acetic acid (10:3) was then added drop-wise to the RVC until saturated. The motor was then engaged and the electrode was spun at a rate such that the suspension remained uniformly distributed within the RVC (˜120 rpm). Indirect heat was applied, and the RVC was heated to 120° C. over the course of 2 minutes, and held there for 3 minutes after which the temperature was slowly reduced to room temperature (10 min). Spin-coating from suspensions varying from 25 mg mL⁻¹ to 125 mg mL⁻¹, were evaluated for film thickness and homogeneity by SEM and FIB (FIG. 3). It was found that optimal coverage in this protocol was achieved via spin-coating with a suspension of 60 mg mL⁻¹ for nanoITO (FIG. 4), nanoFTO (FIG. 5), and nanoATO (FIG. 6). Using 60 mg mL⁻¹ suspensions, homogeneous films without pore blocking were achieved. Additionally, heating and cooling rates were optimized to minimize film cracking due to thermal expansion and contraction of the RVC and transparent conductive oxide (TCO) layer. Again, one of ordinary skill in the art will appreciate that various parameters will affect the application of nanoparticles to the RVC, such as time and temperature, concentration of the suspension, and rates and duration of spinning, for example.

Analysis of film thickness of dip-coated RVC with nanoITO by FIB patterning revealed films with thicknesses from 1 to 4 μm (FIGS. 2e and f). The thickness variations observed are due to local morphological variations in the RVC substrates. ITO suspensions accumulated in valleys with less liquid retained at the edges. Local structural features and mass gains with oxide addition were reproducible. Dip coating with suspensions of 100 mg mL⁻¹ resulted in mass gains of 64±3%. Spin-coated RVC using a 60 mg mL⁻¹ suspension of nanoITO revealed film thicknesses from 1 to 5 μm, with very little thickness variation throughout the exterior pores and interior pores of the material (FIG. 4). The resultant mass gain when spin coating a suspension of 60 mg mL⁻¹ was 62±5%.

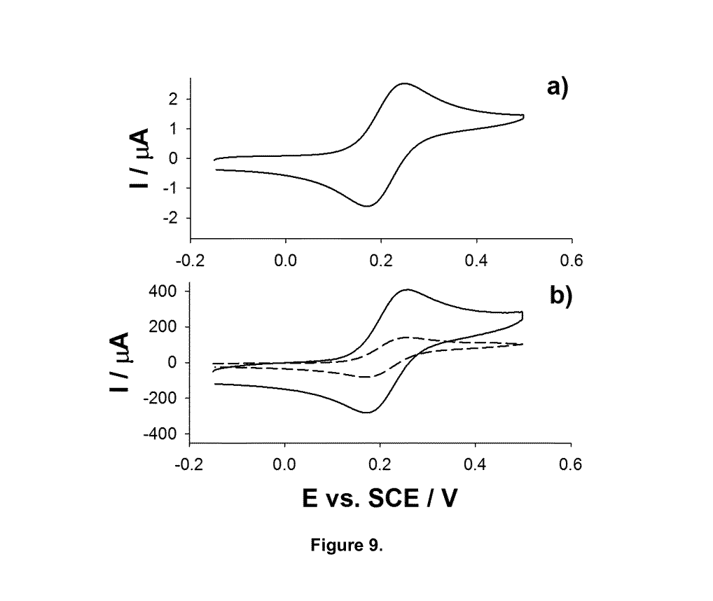

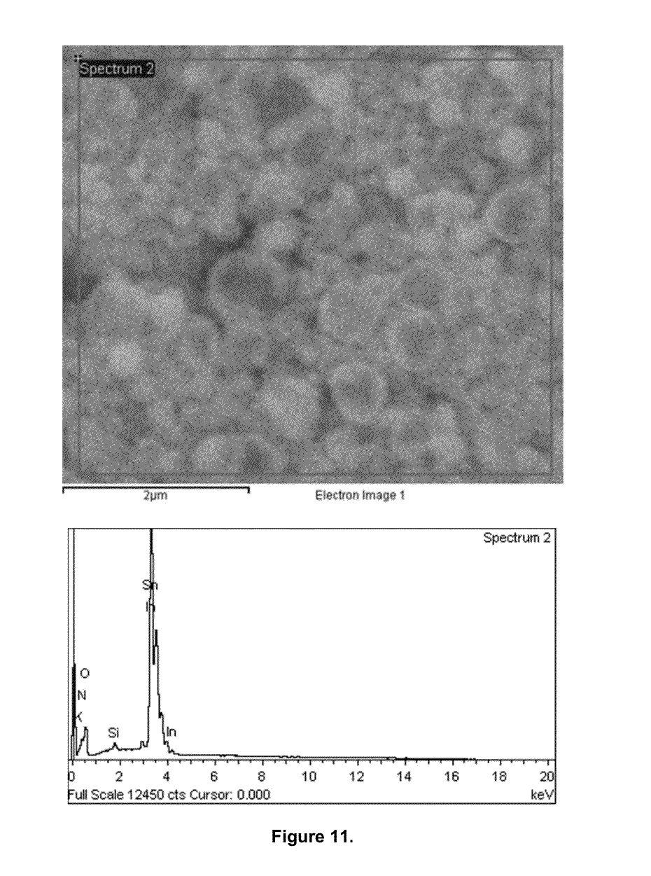

Effective surface areas were evaluated by use of cyclic voltammetry (CV) and measurements on the Fe(CN)₆^{3-/4-} couple, FIG. 9. This couple is reversible on glassy carbon and RVC electrodes appearing at 0.21 V vs. SCE on both (0.45 V vs. NHE). Peak currents on RVC|nanoITO were enhanced by a factor of ˜3 relative to RVC demonstrating an increase in electroactive surface area for the RVC-nanoparticles structure (FIG. 9(b)). Simultaneous energy dispersive X-ray spectroscopy (EDS) measurements confirmed the presence of the oxide nanoparticles with no evidence for carbon inclusion with the stoichiometry of nanoITO maintained (FIG. 11).

Embodiments of the present invention can be used for any suitable purpose. In some cases, electrodes are used to analyze a medium, such as by cyclic voltammetry. In other cases, electrodes are used to catalyze a reaction. In still other cases, embodiments relate to stabilized RVC. In still other cases, embodiments increase the surface area of the RVC. Additional cases provide an increase in electroactive area of the RVC. Still other cases provide an increase in catalytically active area of the RVC. Certain cases provide an RVC-nanoparticle electrode, optionally with one or more catalysts, for oxidizing water to oxygen, and optionally producing hydrogen. Certain other cases provide for oxidation or reduction of suitable substrates to form useful products. For example, chloride ion Cl⁻ can be oxidized to Cl₂ and HOCl. Hydrocarbons can be oxidized or activated for further reaction, in certain additional cases. Certain further cases provide RVC-nanoparticle electrodes for fuel cells, such as anodes and cathodes. Many of those cases can be provided by contacting the RVC with at least one nanoparticle, as described herein.

In another embodiment, RVC|nanoITO electrodes were functionalized by adding 1-PO₃H₂. The synthesis of 1-PO₃H₂ was reported elsewhere. Loading of the catalyst on the oxide surface was carried out by immersing the nanoparticles electrodes in a 0.1 mM solution of 1-PO₃H₂ in methanol for 3 hours.

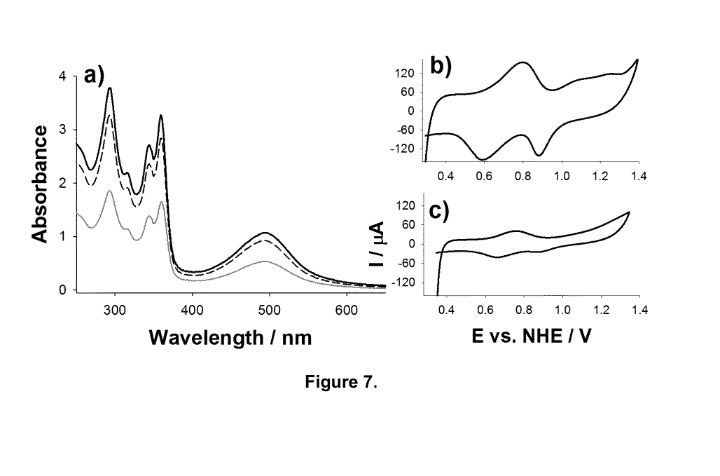

The extent of catalyst loading to RVC|nanoITO increases with the amount of ITO or other nanoparticles. FIG. 7a shows UV-visible spectra of catalyst loading solutions before (Solid Black) and after contact with RVC|nanoITO. RVC|nanoITO made from a suspension of 10 mg mL⁻¹ of nanoITO took enough catalyst to yield the spectrum shown in Dotted Black; while RVC|nanoITO made from a suspension of 100 mg mL⁻¹ took enough catalyst to yield the spectrum shown in Solid Gray. Based on absorbance changes in the catalyst loading solutions at 495 nm before and after loading, suspensions of 10 and 100 mg mL⁻¹ gave loadings of 27 (Γ_{UV-Vis}=1.38 nmol cm⁻²) and 100 nmoles (Γ_{UV-Vis}=5.12 nmol cm⁻²), respectively using the dip-coating method. The same trend was observed by spin-coating method; however, using a suspension of 60 mg mL⁻¹, a surface coverage of 9.5 nmol cm⁻² was obtained.

A similar trend is observed in the CV measurements in FIG. 7b) and c) on the resulting RVC|nanoITO-Ru^{II}-OH₂²⁺ electrodes. A broad, scan-rate dependent wave for the Ru^{III}—OH²⁺/Ru^{II}—OH₂²⁺ couple appears at E_{1/2}=0.77 V vs. NHE with a peak-to-peak separation of ΔEₚ=200 mV at 5 mV/s. Wave shapes and ΔEₚ values are distorted compared to an ideal surface couple due to, it is believed, high catalyst loadings, local heterogeneities, and slow intra-film electron transfer.

Within the same potential window, a further broad oxidative wave is observed at E_{p,a}=1.1 V for the Ru^{IV}═O²⁺/Ru^{III}—OH²⁺ couple. As observed on nanoITO, this couple is kinetically inhibited by the kinetic requirement for proton loss from Ru^{III}-OH²⁺. At 1.2 V, a second, broad oxidation wave is observed of comparable peak current. It arises from direct oxidation of Ru^{III}-OH²⁺ to Ru^{IV}(OH)³⁺, eq. (2), followed by deprotonation, eq. (3). The narrow, re-reduction wave at E_{p,c}=0.88 V arises from Ru^{IV}═O²⁺ re-reduction to Ru^{III}-O²⁺ followed by rapid protonation to give Ru^{III}-OH²⁺.

$$\begin{matrix}{RU}^{III} - {OH}^{2 +} {\to }^{- {e}^{-}} {{Ru}^{IV} ( OH )}^{3 +} & ( 2 ) \\ {{RU}^{IV} ( OH )}^{3 +} {\to }^{- {H}^{+}} {Ru}^{IV} = {O}^{2 +} + {H}^{+} & ( 3 )\end{matrix}$$

The extent of surface loading of electrochemically active 1-PO₃H₂ was determined by integration of the Ru^{II}-OH₂²⁺→Ru^{III}-OH²⁺ oxidation wave at 5 mV/s. Using electrodes fabricated by dip-coating, integration gave 4.3 nmoles (Γ_{e-chem}=0.22 nmol/cm²) from a suspension of 10 mg mL⁻¹ and 23 nmoles (Γ_{e-chem}=1.2 nmol/cm²) from 100 mg mL⁻¹. Comparison of loadings from UV-visible and electrochemical measurements showed that 16% of the sites on RVC|nanoITO-Ru^{II}—OH₂²⁺ from the 10 mg mL⁻¹ suspension were electroactive and 23% from the 100 mg/mL⁻¹ suspension. Electrodes fabricated by spin-coating revealed the same trend. Using a suspension of 60 mg mL⁻¹, a surface coverage of spin coated electrodes of 3.2 nmol cm⁻² was determined, indicating 34% of the loaded catalyst was electrochemically active.

In an earlier study, electrocatalytic oxidation of benzyl alcohol to benzaldehyde by nanoITO-Ru^{II}-OH₂²⁺ was investigated. In that study it was found that oxidation by nanoITO-Ru^{II}-OH²⁺ was slow with k_{Ru}_{^{IV}}_{—O}_{²⁺}=1.3±0.02×10⁻² M⁻¹ s⁻¹ while oxidation by nanoITO-Ru^{IV}(OH)³⁺ occurs with k_{Ru}_{^{IV}}_{(OH)}_{³⁺}=11.1±0.4 M⁻¹ s⁻¹ with a C-H/C-D kinetic isotope effect (KIE) of 3.

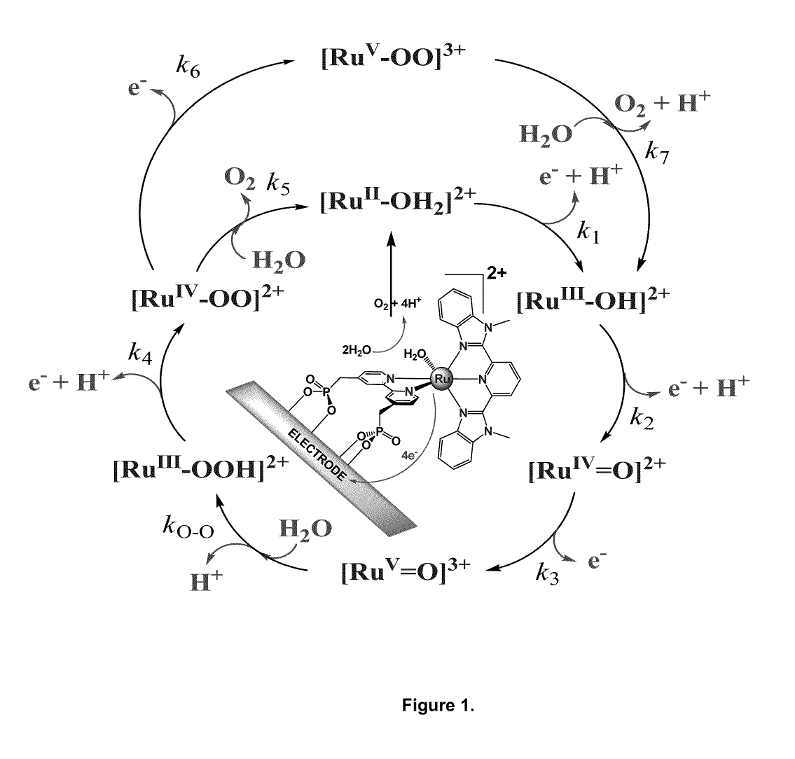

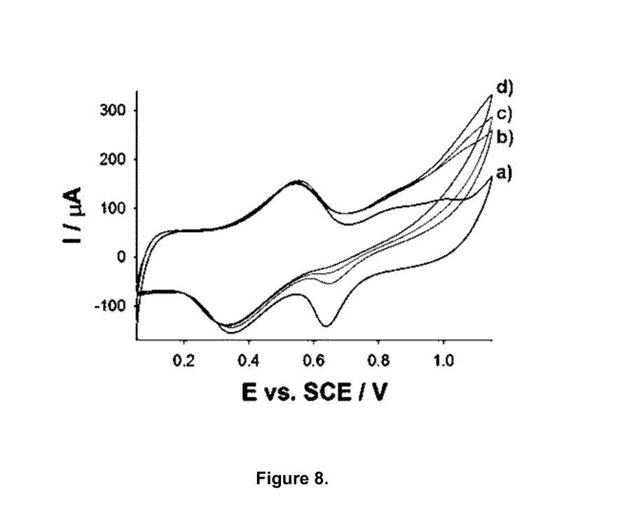

FIG. 8 shows the voltammetric response of RVC|nanoITO-Ru^{II}-OH₂²⁺ in an acetate buffer at pH 5 (I=0.1) with and without added benzyl alcohol. It is notable that, in contrast to nanoITO-Ru^{II}-OH₂²⁺, significant catalytic enhancement occurs at potentials as low as 0.64 V vs. SCE with RVC|nanoITO-Ru^{IV}═O²⁺ as oxidant. This is an impressive manifestation of the increased concentration density of catalyst sites; no enhancement is observed for nanoITO-Ru^{IV}═O²⁺ under the same conditions. At 5 mV/s, oxidation by RVC|nanoITO-Ru^{IV}═O²⁺ is incomplete with additional current enhancement at ˜1 V due to oxidation of the alcohol by RVC|nanoITO-Ru^{IV}(OH)³⁺. Oxidative scans to the RVC|nanoITO-Ru^{IV}(O)²⁺→RVC|nanoITO-Ru^{V}(O)³⁺ wave at E_{p,a}≈1.4 V initiates water oxidation by the cycle in FIG. 1.

$$RVC \vert nanoITO - {Ru}^{IV} = {O}^{2 +} + {PhCH}_{2} OH \to RVC \vert nanoITO - {{Ru}^{II} ( {OH}_{2} )}^{2 +} + PhCHO \qquad ( 4 )$$

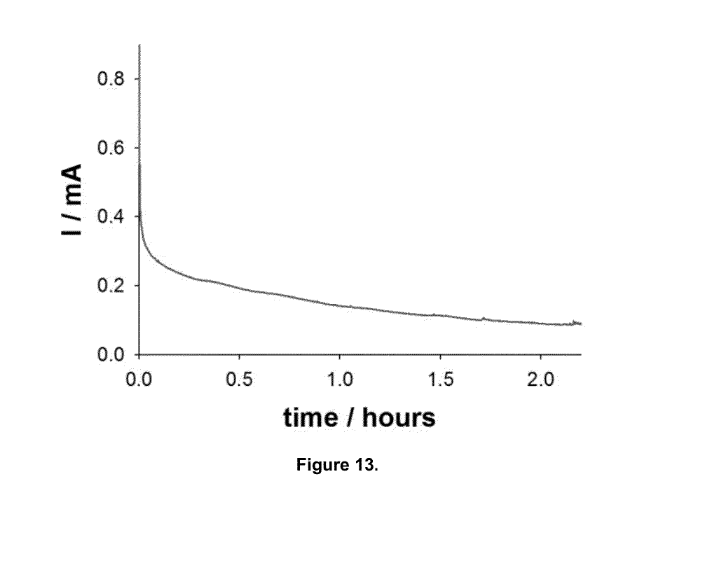

Oxidation of 20 mM benzyl alcohol in acetate buffer at pH 5 (I=0.1) by controlled potential electrolysis at 1.0 V vs. SCE at nanoITO-Ru^{II}-OH₂²⁺ (1 cm²) for 16 hours occurred with passage of 1.5 C giving 4.4 μmoles of benzaldehyde in 57% Faradaic yield. As shown in the current-time curves in FIG. 13, electrolysis of 30 mM of benzyl alcohol at RVC|nanoITO-Ru^{II}-OH₂²⁺ under the same conditions for 2.2 h occurred with passage of 1.2 C producing 4.7 μmoles of benzaldehyde with a Faradaic efficiency of 75%.

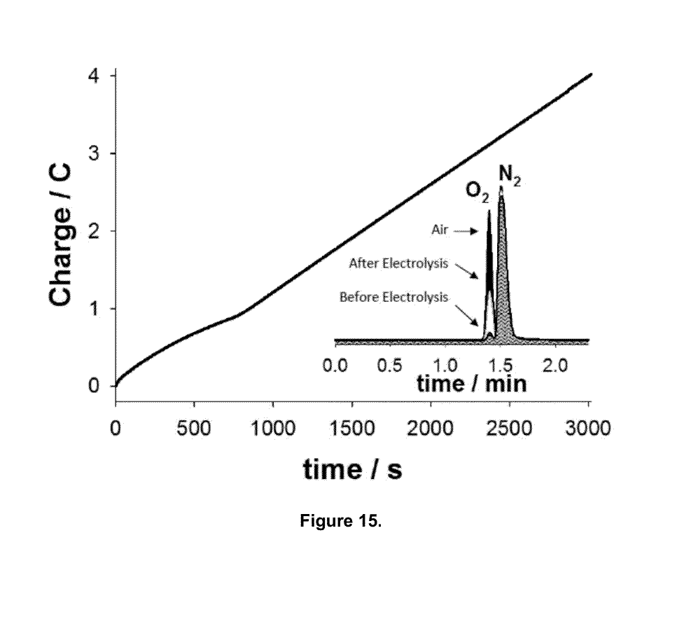

Water oxidation catalysis is also greatly enhanced on RVC|nanoITO-Ru^{II}-OH₂²⁺. Controlled potential electrolysis in 0.1 M HClO₄ at 1.4 V vs. SCE, past E_{p,a} for oxidation of —Ru^{IV}═O²⁺ to —Ru^{V}(O)³⁺, occurred with the passage of 4 C after 50 minutes of electrolysis. GC-FID measurements on a headspace sample showed formation of ˜7.3 μmoles of O₂ and a Faradaic yield of 70% (See FIG. 15). The electrolysis current was stable at 1.4 mA (73 μA/cm²) over the course of the electrolysis demonstrating the stability of the electrode toward sustained water oxidation.

The oxide nanoparticles stabilizes the RVC toward oxidation. A RVC electrode heated in air at 500° C. for 1 hour resulted in 49% loss of the initial mass with noticeable loss of mechanical strength. Under the same conditions, an RVC|nanoITO electrode lost only 16% of its initial mass with its mechanical properties largely intact. Thus, some embodiments relate to stabilizing RVC by placing nanoparticles of a conductive metal oxide in protective communication with the RVC. Protective communication means that the RVC having at least some nanoparticles thereon is measurably more resistant to attack, performs better, and/or lasts longer than RVC in the absence of nanoparticles of a conductive metal oxide. Sometimes, protective communication means there are at least some domains of nanoparticles on the RVC. Other times, protective communication means there is a substantially pore-free continuous coating of at least one nanoparticle on the RVC.

In summary, our results demonstrate successful implementation of an important strategy for obtaining enhanced current densities by placing nanoparticles in electrical communication with RVC. Although potentials and properties of individual sites in the resulting derivatized structures of RVC|nanoITO-Ru^{II}-OH₂²⁺ are relatively unchanged, and some fraction of sites may be electrochemically inactive, significant current enhancements are obtained for electrocatalytic oxidation of both benzyl alcohol and water. Without wishing to be bound by theory, it is believed that the origin of the current enhancement is in an increased density of sites in the highly porous structure of the RVC. The resulting structures, in some embodiments, offer greatly enhanced currents, shortened electrolysis times, and oxidative stability employing these novel hybrid materials.

### EXPERIMENTAL

Chemicals.

Perchloric acid (HClO₄, 70%, redistilled, trace metal grade) and nanoITO (particle size<50 nm) were purchased from Sigma-Aldrich and used as received. Sodium acetate trihydrous, and glacial acetic acid were purchased from Fisher Chemical. Synthesis of [Ru(Mebimpy)(4,4′-((HO)₂OPCH₂)₂bpy)(OH₂)](PF₆)₂ (Mebimpy=2,6-bis(1-methylbenzimidazol-2-yl)pyridine; bpy=2,2′-bipyridine) (1-PO₃H₂) was reported previously. Other chemicals were analytical reagent graded and used as received. All aqueous solutions were prepared with deionized water (Milli Q, Millipore).

Apparatus.

Field emission scanning electron microscopy (SEM) and cross sections obtained using Focused Ion Beam (FIB) is performed on a FEI Helios 600 Nanolab Dual Beam System equipped with a liquid gallium metal ion source. UV-Vis spectra were recorded on a Varian Cary 50 UV-VIS-NIR absorption spectrophotometer. Electrochemical measurements were performed with a model 601 electrochemical workstation from CH Instruments. The three-electrode setup consisted of a reticulated vitreous carbon electrode covered with nanoITO as working electrode, a Pt mesh as counter-electrode and a saturated calomel electrode (SCE) reference electrode. The potential of the SCE reference electrode corresponds to 0.24 V versus NHE. Bulk electrolysis experiments were performed in a glass frit-separated two compartment cell. For cyclic voltammetry (CV) measurements, the working electrode and the counter electrode were placed in the same compartment. The gas product analysis was conducted by gas chromatography (Varian 450-GC, molecular sieve columns, pulsed discharge helium ionization detector). Analysis of electrolysis products in the liquid phase were performed by ¹H-NMR spectroscopy recorded on a Bruker NMR spectrometer AVANCE-500. ¹H spectra were referenced to residual solvent signals. Extraction of products from bulk electrolysis solution aliquots (0.5 ml) were performed using CDCl₃ (1 ml). 0.7 mL of the extract in CDCl₃ is transferred to a NMR tube and 2.5 μL of CH₂Cl₂ is added as internal standard. All standard solutions of benzaldehyde in CDCl₃ were prepared in the same way.

Electrode pretreatment.

Reticulated vitreous carbon (RVC, pores/inch=45; porosity: 96.5%; bulk density: 0.048 g cm⁻³; 10×10×6 mm, geometric area=19.2 cm²) electrode: Prior to experiments RVC electrodes were cleaned by immersion in ethanol for ˜20 min followed by drying under a stream of N₂ gas.

Glassy carbon (0.071 cm²) disk electrode: Prior to the experiments, the glassy carbon electrode was polished with 0.05 and 1.0 um Al₂O₃ slurry to obtain a mirror surface followed by sonication in distilled water for ˜3 minutes to remove debris and was thoroughly rinsed with Milli-Q ultrapure water.

Preparation of nanoITO/RVC Electrodes.

Acetic acid was added in an equal amount in mass to nanoITO followed by different amounts of 200 proof ethanol to afford suspensions of ITO nanoparticles of 10, 100 and 200 mg/mL. The suspensions were sonicated for 5 minutes after manual shaking using a Branson ultrasonic horn flat microtip (20 kHz, 60% power, 50% duty cycle). The suspension was allowed to cool to room temperature before further use.

Previously cleaned RVC electrodes were placed in a 5 mL cylindrical container and the ITO suspension was added until the electrode was completely covered. After gently shaking manually, the electrodes were allowed to be in contact with the ITO nanoparticles suspension for 10 minutes. Immediately after the electrodes containing ITO suspension within their pores were carefully extracted from the ethanolic suspension and placed in petri dishes for annealing under a steady flow of 5% H₂/N₂ in a tube furnace at 500° C. for 1 hour. The modified electrodes were allowed to slowly cool to room temperature under H₂/N₂ and used with no further modification.

Catalyst Loading:

Stable phosphonate surface binding of the catalyst on nanoITO films to give 1-PO₃H₂ occurred following immersion of the nanoITO/RVC electrodes in solutions containing 0.1 mM catalyst in methanol for 3 hours. Adsorption isotherms for this system have been previously reported. Typical saturated surface coverage occurs within two hours.

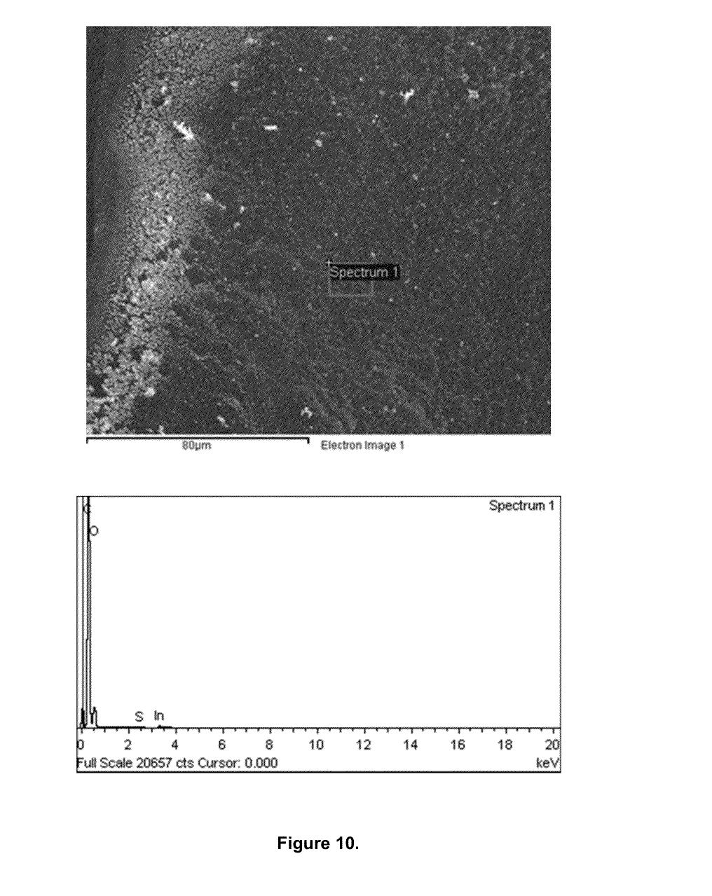

FIG. 10 shows an SEM micrograph (top) of an uncovered area of an RVC/nanoITO electrode prepared from a 10 mg/mL suspension of nanoITO in ethanol. Only small residual amounts of tin and indium are present, as revealed by EDS (FIG. 10, Bottom) and shown in Table 1.

TABLE 1
EDS elemental analysis of the spectrum presented in FIG. 6, bottom.

| | Weight Percentage | Atomic Percentage |
|---|---|---|
| Element | (%) | (%) |
| C | 76.93 | 82.21 |
| O | 22.00 | 17.65 |
| Si | 0.08 | 0.03 |
| In | 0.99 | 0.11 |

FIG. 11 (Top) shows a SEM micrograph of a covered area of RVC|nanoITO electrodes prepared from a 100 mg/mL suspension of nanoITO in ethanol. ITO nanoparticles are visible. EDS data (FIG. 11 (Bottom) and Table 2 below) confirm the identity of the nanoparticles.

TABLE 2
EDS elemental analysis of the spectrum presented in FIG. 11, Bottom.

| | Weight Percentage | Atomic Percentage |
|---|---|---|
| Element | (%) | (%) |
| N | 4.89 | 13.30 |
| O | 26.38 | 62.82 |
| Si | 0.58 | 0.79 |
| K | 0.91 | 0.89 |
| In | 58.01 | 19.26 |
| Sn | 9.23 | 2.94 |

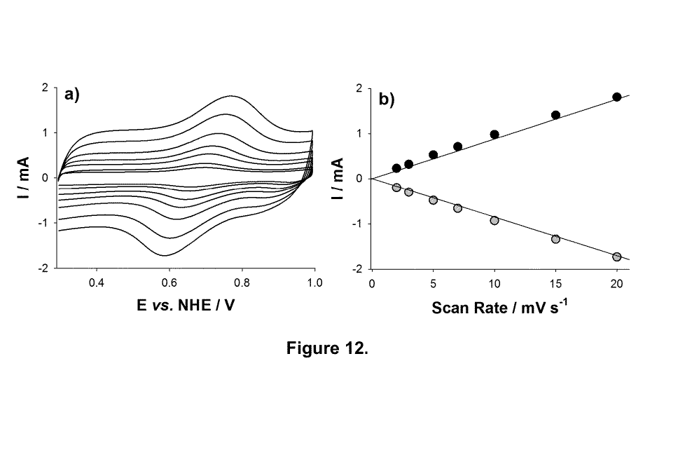

FIG. 12(a) shows cyclic voltammograms in pH 5 acetate buffer (I=0.1 M) of RVC|nanoITO-Ru^{II}-OH₂²⁺ electrodes previously loaded with 1-PO₃H₂ at varying scan rates. In accordance with theoretical descriptions of CV experiments of surface-attached electrochemically active species, the current is directly proportional to the scan rate, as shown in FIG. 12(b).

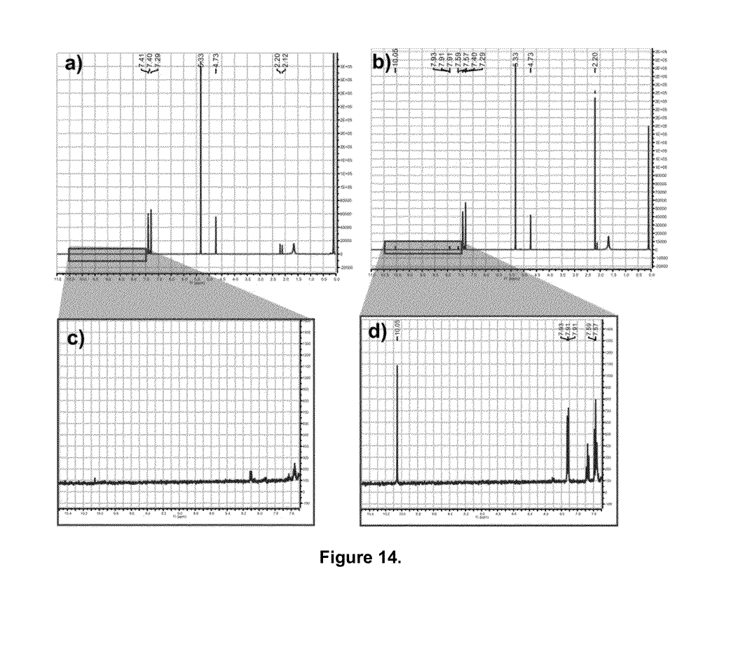

FIG. 14 shows proton NMR of the extract in CDCl₃ of the liquid phase in FIG. 13 at electrolysis times of a) 0 and b) 2.2 hours. Enlarged spectra of a) and b) in the region comprehended between 10.5 and 7.5 ppm are presented in c) and d), respectively. These experiments confirmed the selective formation of benzaldehyde, as evidenced by the appearance of only a typical ¹H-NMR signal at 10.1 ppm for benzaldehyde after electrolysis (FIG. 14d).

FIG. 15 shows charge passed as a function of time for a controlled electrolysis experiment for oxygen production at RVC|nanoITO-Ru^{II}—OH₂²⁺ electrodes previously loaded with 1-PO₃H₂ in HClO₄ 0.1 M at 1.4 V vs. SCE. The inset shows the gas chromatogram obtained before electrolysis (Hatched), after 50 minutes (White) and an air sample (Black).

### REFERENCES

(1) Bel Hadj Tahar, R.; Ban, T.; Ohya, Y.; Takahashi, Y. J. Appl. Phys. 1998, 83, 2631.
(2) (a) Concepcion, J. J.; Jurss, J. W.; Hoertz, P. G.; Meyer, T. J. Angew. Chem. Int. Ed. 2009, 48, 9473. (b) Chen, Z.; Concepcion, J. J.; Hull, J. F.; Hoertz, P. G.; Meyer, T. J. Dalton Transactions 2010, 39, 6950. (c) Chen, Z.; Concepcion, J. J.; Luo, H.; Hull, J. F.; Paul, A.; Meyer, T. J. J. Am. Chem. Soc. 2010, 123, 17670. (d) Hoertz, P. G.; Chen, Z.; Kent, C. A.; Meyer, T. J. Inorg. Chem. 2010, 49, 8179.
(3) (a) Paul, A.; Hull, J. F.; Norris, M. R.; Chen, Z.; Ess, D. H.; Concepcion, J. J.; Meyer, T. J. Inorg. Chem. 2011, 50, 1167. (b) Vannucci, A. K.; Hull, J. F.; Chen, Z.; Binstead, R. a.; Concepcion, J. J.; Meyer, T. J. J. Am. Chem. Soc. 2012, 134,
3972. (c) Vannucci, A. K.; Chen, Z.; Concepcion, J. J.; Meyer, T. J. ACS Catalysis 2012, 2, 716.
(4) (a) Gagliardi, C. J.; Jurss, J. W.; Thorp, H. H.; Meyer, T. J. Inorg. Chem. 2011, 50, 2076. (b) Gagliardi, C. J.; Westlake, B. C.; Kent, C. A.; Paul, J. J.; Papanikolas, J. M.; Meyer, T. J. Coord. Chem. Rev. 2010, 254, 2459.
(5) Chen, Z.; Concepcion, J. J.; Jurss, J. W.; Meyer, T. J. J. Am. Chem. Soc. 2009, 131, 15580.
(6) Friedrich, J. M.; Ponce-de-León, C.; Reade, G. W.; Walsh, F. C. J. Electroanal. Chem. 2004, 561, 203.
(7) (a) Curran, D. J.; Tougas, T. P. Anal. Chem. 1984, 56, 672. (b) Zhu, C.; Curran, D. J. Electroanalysis 1991, 3, 511.
(8) Recio, F. J.; Herrasti, P.; Sirés, I.; Kulak, A. N.; Bavykin, D. V.; Ponce-de-León, C.; Walsh, F. C. Electrochim. Acta 2011, 56, 5158.
(9) Sorrels, J. W.; Dewald, H. D. Anal. Chem. 1990, 62, 1640.
(10) Arredondo Valdez, H. C.; Garcia Jiménez, G.; Gutiérrez Granados, S.; Ponce de León, C. Chemosphere 2012, 89, 1195.
(11) Frydrychewicz, A.; Yu, S.; Tsirlina, G. A.; Jackowska, K. Electrochim. Acta 2005, 50, 1885.
(12) Concepcion, J. J.; Jurss, J. W.; Norris, M. R.; Chen, Z.; Templeton, J. L.; Meyer, T. J. Inorg. Chem. 2010, 49, 1277.

### Embodiments

### Embodiment 1

An electrode comprising: reticulated vitreous carbon and

nanoparticles of a conductive metal oxide in electrical communication with the reticulated vitreous carbon.

### Embodiment 2

The electrode of embodiment 1, wherein the nanoparticles are optically transparent.

### Embodiment 3

The electrode of any one of embodiments 1-2, wherein the nanoparticles comprise tin-doped indium oxide.

### Embodiment 4

The electrode of any one of embodiments 1-3, wherein the nanoparticles comprise antimony tin oxide.

### Embodiment 5

The electrode of any one of embodiments 1-4, wherein the nanoparticles comprise tin-doped indium oxide (ITO), fluorine-doped tin oxide (FTO), antimony tin oxide (ATO), gallium zinc oxide (GZO), indium zinc oxide (IZO), copper aluminum oxide, fluorine-doped zinc oxide, aluminum zinc oxide (AZO), or a combination thereof.

### Embodiment 6

The electrode of any one of embodiments 1-5, further comprising at least one transition metal catalyst.

### Embodiment 7

The electrode of embodiment 6, wherein the at least one transition metal catalyst comprises {Ru(Mebimpy)[4,4′-((HO)₂OPCH₂)₂bpy](OH₂)}²⁺, a monodeprotonated derivative thereof, a dideprotonated derivative thereof, or a combination thereof.

### Embodiment 8

A method for preparing an electrode comprising: annealing reticulated vitreous carbon in the presence of nanoparticles of a conductive metal oxide for a period of time and at a temperature sufficient to place at least some of the nanoparticles in electrical communication with the reticulated vitreous carbon,

thereby preparing the electrode.

### Embodiment 9

The method of embodiment 8, further comprising: exposing the electrode to a composition comprising at least one transition metal catalyst.

### Embodiment 10

The method of embodiment 9, wherein the at least one transition metal catalyst comprises {Ru(Mebimpy)[4,4′-((HO)₂OPCH₂)₂bpy](OH₂)}²⁺, a monodeprotonated derivative thereof, a dideprotonated derivative thereof, or a combination thereof.

### Embodiment 11

The method of any one of embodiments 8-10, wherein the nanoparticles comprise tin-doped indium oxide (ITO), fluorine-doped tin oxide (FTO), antimony tin oxide (ATO), gallium zinc oxide (GZO), indium zinc oxide (IZO), copper aluminum oxide, fluorine-doped zinc oxide, aluminum zinc oxide (AZO), or a combination thereof.

### Embodiment 12

The method of any one of embodiments 8-10, wherein the nanoparticles comprise tin-doped indium oxide (ITO).

### Embodiment 13

The method of any one of embodiments 8-10, wherein the nanoparticles comprise antimony tin oxide (ATO).

### Embodiment 14

The method of any one of embodiments 8-13, wherein annealing comprises heating the reticulated vitreous carbon and nanoparticles at a temperature ranging from about 100° C. to about 200° C. in the substantial absence of oxygen.

### Embodiment 15

The method of any one of embodiments 8-14, wherein annealing comprises heating the reticulated vitreous carbon and nanoparticles at a temperature ranging from about 400° C. to about 600° C. in the substantial absence of oxygen.

### Embodiment 16

A method for electrolyzing a reactant, comprising: providing an electrochemical cell having an electrode that comprises reticulated vitreous carbon and nanoparticles of a conductive metal oxide in electrical communication with the reticulated vitreous carbon;

contacting the electrode with the reactant;
applying electrical energy to the electrode, thereby electrolyzing the reactant.

### Embodiment 17

The method of embodiment 16, wherein the nanoparticles are optically transparent.

### Embodiment 18

The method of any one of embodiments 16-17, wherein the nanoparticles comprise tin-doped indium oxide.

### Embodiment 19

The method of any one of embodiments 16-18, wherein the nanoparticles comprise antimony tin oxide.

### Embodiment 20

The method of any one of embodiments 16-19, wherein the nanoparticles comprise tin-doped indium oxide (ITO), fluorine-doped tin oxide (FTO), antimony tin oxide (ATO), gallium zinc oxide (GZO), indium zinc oxide (IZO), copper aluminum oxide, fluorine-doped zinc oxide, aluminum zinc oxide (AZO), or a combination thereof.

### Embodiment 21

The method of any one of embodiments 16-20, wherein the electrode further comprises at least one transition metal catalyst.

### Embodiment 22

The method of embodiment 21, wherein the at least one transition metal catalyst comprises {Ru(Mebimpy)[4,4′-((HO)₂OPCH₂)₂bpy](OH₂)}²⁺, a monodeprotonated derivative thereof, a dideprotonated derivative thereof, or a combination thereof.

### Embodiment 23

A method for stabilizing reticulated vitreous carbon, comprising:

annealing reticulated vitreous carbon in the presence of nanoparticles of a conductive metal oxide for a period of time and at a temperature sufficient to place at least some of the nanoparticles in protective communication with the reticulated vitreous carbon,
thereby stabilizing the reticulated vitreous carbon.

### Embodiment 24

The method of embodiment 23, wherein the nanoparticles comprise tin-doped indium oxide (ITO), fluorine-doped tin oxide (FTO), antimony tin oxide (ATO), gallium zinc oxide (GZO), indium zinc oxide (IZO), copper aluminum oxide, fluorine-doped zinc oxide, aluminum zinc oxide (AZO), or a combination thereof.

### Embodiment 25

The method of any one of embodiments 23-24, wherein the nanoparticles comprise tin-doped indium oxide (ITO).

### Embodiment 26

The method of any one of embodiments 23-25, wherein the nanoparticles comprise antimony tin oxide (ATO).

### Embodiment 27

The method of any one of embodiments 23-26, wherein annealing comprises heating the reticulated vitreous carbon and nanoparticles at a temperature ranging from about 100° C. to about 200° C. in the substantial absence of oxygen.

### Embodiment 28

The method of any one of embodiments 23-27, wherein annealing comprises heating the reticulated vitreous carbon and nanoparticles at a temperature ranging from about 400° C. to about 600° C. in the substantial absence of oxygen.

As previously stated, detailed embodiments of the present invention are disclosed herein; however, it is to be understood that the disclosed embodiments are merely exemplary of the invention that may be embodied in various forms. It will be appreciated that many modifications and other variations are within the intended scope of this invention as claimed below. Furthermore, the foregoing description of various embodiments does not necessarily imply exclusion. For example, “some” embodiments may include all or part of “other” and “further” embodiments within the scope of this invention. In addition, “a” does not mean “one and only one;” “a” can mean “one and more than one.”

I claim:

1. An electrode comprising:
reticulated vitreous carbon and
nanoparticles of a conductive metal oxide in electrical communication with the reticulated vitreous carbon.

2. The electrode of claim 1, wherein the nanoparticles are optically transparent.

3. The electrode of claim 1, wherein the nanoparticles comprise tin-doped indium oxide.

4. The electrode of claim 1, wherein the nanoparticles comprise antimony tin oxide.

5. The electrode of claim 1, wherein the nanoparticles comprise tin-doped indium oxide (ITO), fluorine-doped tin oxide (FTO), antimony tin oxide (ATO), gallium zinc oxide (GZO), indium zinc oxide (IZO), copper aluminum oxide (CAO), fluorine-doped zinc oxide (FZO), aluminum zinc oxide (AZO), or a combination thereof.

6. The electrode of claim 1, further comprising at least one transition metal catalyst.

7. The electrode of claim 6, wherein the at least one transition metal catalyst comprises {Ru(Mebimpy)[4,4′-((HO)₂OPCH₂)₂bpy](OH₂)}²⁺, a monodeprotonated derivative thereof, a dideprotonated derivative thereof, or a combination thereof.

8. A method for preparing an electrode comprising:
annealing reticulated vitreous carbon in the presence of nanoparticles of a conductive metal oxide for a period of time and at a temperature sufficient to place at least some of the nanoparticles in electrical communication with the reticulated vitreous carbon,
thereby preparing the electrode.

9. The method of claim 8, further comprising:
exposing the electrode to a composition comprising at least one transition metal catalyst.

10. The method of claim 9, wherein the at least one transition metal catalyst comprises {Ru(Mebimpy)[4,4′-((HO)₂OPCH₂)₂bpy](OH₂)}²⁺, a monodeprotonated derivative thereof, a dideprotonated derivative thereof, or a combination thereof.

11. The method of claim 8, wherein the nanoparticles comprise tin-doped indium oxide (ITO), fluorine-doped tin oxide (FTO), antimony tin oxide (ATO), gallium zinc oxide (GZO), indium zinc oxide (IZO), copper aluminum oxide (CAO), fluorine-doped zinc oxide (FZO), aluminum zinc oxide (AZO), or a combination thereof.

12. The method of claim 8, wherein the nanoparticles comprise tin-doped indium oxide (ITO).

13. The method of claim 8, wherein the nanoparticles comprise antimony tin oxide (ATO).

14. The method of claim 8, wherein annealing comprises heating the reticulated vitreous carbon and nanoparticles at a temperature ranging from about 100° C. to about 200° C. in the substantial absence of oxygen.

15. The method of claim 8, wherein annealing comprises heating the reticulated vitreous carbon and nanoparticles at a temperature ranging from about 400° C. to about 600° C. in the substantial absence of oxygen.

16. A method for electrolyzing a reactant, comprising:
providing an electrochemical cell having an electrode that comprises reticulated vitreous carbon and nanoparticles of a conductive metal oxide in electrical communication with the reticulated vitreous carbon;
contacting the electrode with the reactant;
applying electrical energy to the electrode, thereby electrolyzing the reactant.

17. The method of claim 16, wherein the nanoparticles are optically transparent.

18. The method of claim 16, wherein the nanoparticles comprise tin-doped indium oxide.

19. The method of claim 16, wherein the nanoparticles comprise antimony tin oxide.

20. The method of claim 16, wherein the nanoparticles comprise tin-doped indium oxide (ITO), fluorine-doped tin oxide (FTO), antimony tin oxide (ATO), gallium zinc oxide (GZO), indium zinc oxide (IZO), copper aluminum oxide (CAO), fluorine-doped zinc oxide (FZO), aluminum zinc oxide (AZO), or a combination thereof.
